(19) United States
(12) Patent Application Publication
(10) Pub. No.: US 2020/0274693 A1
(43) Pub. Date: Aug. 27, 2020

(54) FURTHER METHODS AND APPLICATIONS OF TRANS ENCRYPTION

(71) Applicant: TFOR LLC, Reston, VA (US)

(72) Inventor: David von Vistauxx, Silver Spring, MD (US)

(73) Assignee: TFOR LLC, Reston, VA (US)

(21) Appl. No.: 16/634,569

(22) PCT Filed: Jul. 27, 2018
(86) PCT No.: PCT/US2018/044257

§ 371 Date: Jan. 27, 2020

Related U.S. Application Data
(60) Provisional application No. 62/537,950, filed on Jul. 27, 2017.

(51) Int. Cl. H04L 9/06; G06F 21/62

(52) U.S. Cl. CPC H04L 9/0637; H04L 2209/04; H04L 2209/38; G06F 21/6218

(57) ABSTRACT

In a system and method of generating within an unrestricted domain non-informational data D from an operation on informational data with non-informational data E, the inverse of said operation on data E with data D restoring said informational data, data D and data E being stored such that one but not the other is stored in a first information-restricted domain, an improvement that limits re-instantiation of the informational data to registers in the processor.

### BACKGROUND

Trans Encryption (TE) is a suite of techniques based on removing information (“informational data”) from data, so that the result is non-informational data (“NID”). This is to be distinguished from encryption, which encodes the informational data with a key that through a variety of strategies can be hacked and the informational data uncovered. With use of TE the typical removal result is two data strings of the same length as the informational data, where neither string contains any information and, therefore, cannot be hacked in the manner of key encrypted information. Consequently, each non-informational data (NID) string can be stored using normal protocols applicable to non-sensitive information.

In the use of TE there are two categories of locations, 1) domains which are subject to such protections and limitations of scope that the removed information may be examined and 2) domains which are not subject to such protections against compromise. The former domains are “unrestricted domains” because it is allowable for the informational data to be present in those domains. These are the domains where the informational data may be processed into NID strings or where the informational data may be recovered from the NID strings. The latter are “information-restricted domains” because the informational data is not allowed to be present in these domains. These are the domains where the NID strings may be stored openly without exposing the actual information to compromise.

Trans Encrypted Storage (TES) refers to the strategy for managing the storage of the NID strings, in those applications of TE where the time between removal of information from data (i.e. by creation of NID strings) and retrieval of the information for use is not transient. This is the usual case for owners of information who desire to maintain their ability to access the information over periods of time without incurring added costs for protecting the information from unauthorized access. However voluminous, sensitive or private the information may be, it simply is not present in storage during these periods of time when the owner does not need access to the information. All that is required to maintain continuity of the ability to access the information during these time periods is knowledge of the location of the constituent NID strings. This knowledge is in the form of directory entries which are well understood in the art. It is important to note that this knowledge comprises a) a plurality of such entries and b) the connection among these entries.

The widespread use of electronic data storage that can be accessed via a computer network has inherent vulnerabilities. Large corporations and government agencies have been the victims of embarrassing and costly data security breaches perpetrated via remote computers. A wide variety of techniques for protecting data and computer networks are known, including but not limited to firewalls, password protection and encryption. However, such techniques may need to be frequently updated to defend against newly developed attack techniques and newly discovered vulnerabilities. Moreover, such techniques do not guarantee security. For example, encrypted and password-protected data may be stolen in a protected form and security features subsequently defeated in an offline attack. Techniques for securing data and networks may also hinder data access and data management.

The widespread use of electronic data transmission utilizing various networking technologies including, but not limited to, IPv4, IPv6 and various streaming technologies have inherent vulnerabilities and potential leakage. In addition, the recently added technology currently referred to as “Software Defined Networking” (SDN) allows routing of packets and streams from a starting point to an end point without the traditional transitions through hardware routers. SDN is an approach to networking that allows management of network behavior by administrators by decoupling the system that makes decisions about where traffic is sent (commonly referred to as SDN Controllers) from the underlying systems that forward traffic. This abstraction of lower-level functionality is meant to address the fact that the static architectures of traditional networks don't support the dynamic, scalable computing, routing, and storage needs of modern computing environments like cloud computing and modern data centers. Artifact data is used to encapsulate the information as each of these hardware routers forwards the information.

With recent changes in laws, both domestic and international, it is possible that the mere transition of a packet or stream through a specific jurisdiction would have legal ramifications for the information contained in the packet or stream. Corporations, large and small, and governments (at all levels) utilize various techniques to ensure that their data is not compromised during this transmission. Notably they will either use end to end encryption or technologies such as Virtual Private Networking (VPN). In some uses only a very expensive point-to-point physical connection (either optical or electrical) is permitted to ensure against compromise. These technologies (other than the very expensive point-to-point connections) provide no assurance that the information (in its encrypted form) was not disclosed to a third party, nor do these technologies assure where (in jurisdictional terms) a portion or the entire stream of packets has been. A single compromised router in the transmission chain or a forced change in the routing table (using standard routing table broadcast techniques) to force packets and streams through a compromised router can disclose this information (even if encrypted in form) to unauthorized third parties.

Corporations, government agencies, and individual home users have been the victims of embarrassing and costly breaches of routers, and once breached and the encrypted information disclosed, it is merely time before the key can be ascertained. The time to ascertain this key has been dropping following a near geometric, not linear, curve. A wide variety of techniques for protecting computer networks are known, including but not limited to firewalls, password protection and encryption. However, such techniques may need to be frequently updated to defend against newly developed attack techniques and newly discovered vulnerabilities. Moreover, such techniques do not guarantee security. For example, encrypted and password-protected information may be stolen in a protected form and security features subsequently defeated in an offline attack. Techniques for securing information and networks may also hinder access to the information and management of the data containing the information.

Trans Encryption Cascading (TEC) is a routing technique that operates by identifying one or more nodes along a route for transmitting information from an upstream source to a downstream destination, associating with each identified node a stream of random data, combining at each identified node the received upstream data with the associated stream of random data, forwarding the combined data downstream, and cascading the random data streams associated with the identified nodes, so that the information from the combined downstream data at the downstream destination is recoverable by applying the cascade of the random data streams. The cascade of the random data streams can be constructed by the addition of the random data strings used at successive applications of respective random data streams to randomize the upstream data received at the respective nodes. The storage and retrieval of the randomized downstream data and the cascade of the random data streams is organized so that recovery of the information is limited to a user of TEC, and to a user device which need not retain the information beyond any viewing necessary to satisfy the purposes of retrieval and recovery.

Sensitive information transmitted using TEC may not be immediately recoverable at the receiving end because the information traversed a different path (switched through different routers/different “Software Defined Routing” (SDR) paths) and the cascade encryption will fail due to the addition or deletion of artifact data by intervening routers. For example, information transmitted by a military service from Washington D.C. to Boston Mass. may use TEC based upon it being routed through Virginia, New York, and Boston between the origin and the terminus. If the data is diverted from one of these routers to a router in China, two things will happen: 1) the data received in Boston will not be recoverable (the TEC will fail), and 2) the data received in China will also not be recoverable. The data received in China will be only a uniquely encrypted version of the encrypted data received by the specific router that routed the packet or stream to China. Without the artifact data of the “past and future routers” (all routers between Washington D.C. source router and Boston) all China has received is truly random data. Thus, less reliance on security may be required.

Memory controllers contain the logic necessary to read and write to Dynamic Random Access Memory (DRAM) and to refresh the DRAM. A few experimental memory controllers (mostly aimed at the server market where data protection is legally required) contain a second level of address translation, in addition to the first level of address translation performed by the CPU's memory management unit (MMU). Memory controllers integrated into certain Intel Core processors also provide memory scrambling as a feature that turns user data written to the main memory into pseudo random patterns. This feature, while ostensibly adding security, is primarily aimed at minimizing the impact of DRAM-related electrical problems.

Memory Scrambling (in Cryptographic Theory) is supposed to prevent forensic and reverse-engineering analysis based on DRAM data remanence by effectively rendering various types of cold boot attacks ineffective. In current practice this has not been achieved. Current Memory Scrambling standards are not cryptographically secure, or necessarily open sourced or open to public revision or analysis. Various manufacturers have their own memory scrambling standards and some manufacturers allow the user to select the standard or turn it off entirely.

Memory controllers can be connected to different services at the same time, such as SDRAM, SRAM, ROM, Memory-mapped I/O, and external storage controllers among others. The purpose of a memory controller is to present a standardized system bus/front-side bus to the processor while presenting an appropriate control bus to the memory/storage device.

### SUMMARY

All examples, aspects and features mentioned in this document can be combined in any technically possible way.

It is an object of the invention to practice TE in such a manner that informational data is never stored, but is merely instantiated.

Some aspects of the invention may be predicated in-part on recognition that removal of information from computer buses and data stored in memory may enhance security. For example, multiple methods are known to monitor the data buses and the information that transits them. Methods are known to use forensic analysis based upon data remanence to execute cold boot attacks (only possible if information is stored in memory). Users with access to the physical machine and other Virtual machines operating on the physical machine may have access to this information. By removing the information from the buses and memory of the machine security is enhanced. Consequently, simpler methods can be used to provide security in operating systems. Moreover, less reliance on security of transmitted or stored data may be required.

The invention may be implemented with a memory controller (whether a separate chip or integrated into the CPU die). This functionality is sometimes referred to as integrated memory controller (IMC) if it is on the CPU die, a memory chip controller (MCC) or a memory controller unit (MCU); This memory controller has a) separate access to multiple banks of memory or storage channels, b) a circuit within this controller that can generate random bytes, c) a circuit within this controller that can XOR these random bytes with information to be stored in memory or transmitted to a sub controller (i.e. Northbridge or Southbridge) or via a circuit that stores the random byte in (for instance) the even bank (banks 0,2,4,8 etc.) and the XORED information/random byte in the odd bank (1,3,5,7 etc.) as one or many storage cycles; a circuit that flags when this storage procedure is complete. In some implementations the generation of random bytes is replaced with access to random bytes already in memory. In some implementations the apparatus comprises an inverse function that uses the (for instance) random data from bank 0 and the random data from bank 1 to re-instantiate the information for transmission to the CPU.

In some implementations the apparatus is isolated such that the CPU/IMC (MCC, MCU) receives stored random bytes, re-instantiates the information only in the CPUs registers, operates on the re-instantiated information based upon operation codes provided to the CPU on an instruction (or similar) bus, and then stores the resulting information via the IMC/MCC/MCU as random data in memory banks (an implementation of what is called “homomorphic encryption”).

In multiprocessor configurations compromise of memory does not compromise information. Crash dumps of memory do not compromise information, and information exists only in CPU registers during computation or comparison operations;

### BRIEF DESCRIPTION OF THE FIGURES

FIG. 1 is a block diagram illustrating reversible removal of information from data stored in memory banks within the computer.

FIG. 2 illustrates the actual process of creating non-information to be stored in memory from the Memory controller interface (CPU side) to the actual memory of the machine. Note that the cache is on the CPU side before the memory controller interface so that it does not interfere with technique and vice versa. FIG. 2 shows the use of a random byte generator to create the random data to be XORed with the information from the CPU to generate the non-informational data to be stored in memory

FIG. 3 is similar to FIG. 2 with the exception that the random bytes used to generate non-informational data are sourced from a known but random place in memory. This technique has the advantage of requiring half the storage of FIG. 2 to save the same amount of non-informational data.

FIG. 4 illustrates re-instantiation of the saved information by accessing the random bytes and the XORed information/random bytes and using the memory controller interface to save the information to the CPU.

FIG. 4A shows the same re-instantiation as FIG. 4, with a mask for the control of re-instantiated information.

FIG. 5 illustrates a possible external device implementation. In this implementation both the MIC/IMC and the external Graphics controller have a Deterministic Random Bit Generator (DRBG) generating random data from the same key. These two DRBG will output the same stream of bits with the same key.

### DETAILED DESCRIPTION

Some aspects, features, and implementations may comprise computer components and computer-implemented steps or processes that will be apparent to those of ordinary skill in the art. It should be understood by those of ordinary skill in the art that the computer-implemented steps or processes may be stored as computer-executable instructions on a non-transitory computer-readable medium. Furthermore, it should be understood by those of ordinary skill in the art that the computer-executable instructions may be executed on a variety of physical processor devices. For ease of exposition, not every step, process or element is described herein as part of a computer system. However, those of ordinary skill in the art will recognize steps, processes and elements that may have a corresponding computer system or software component. Such computer system and software components are therefore enabled by describing their corresponding steps, processes or elements, and are within the scope of the disclosure.

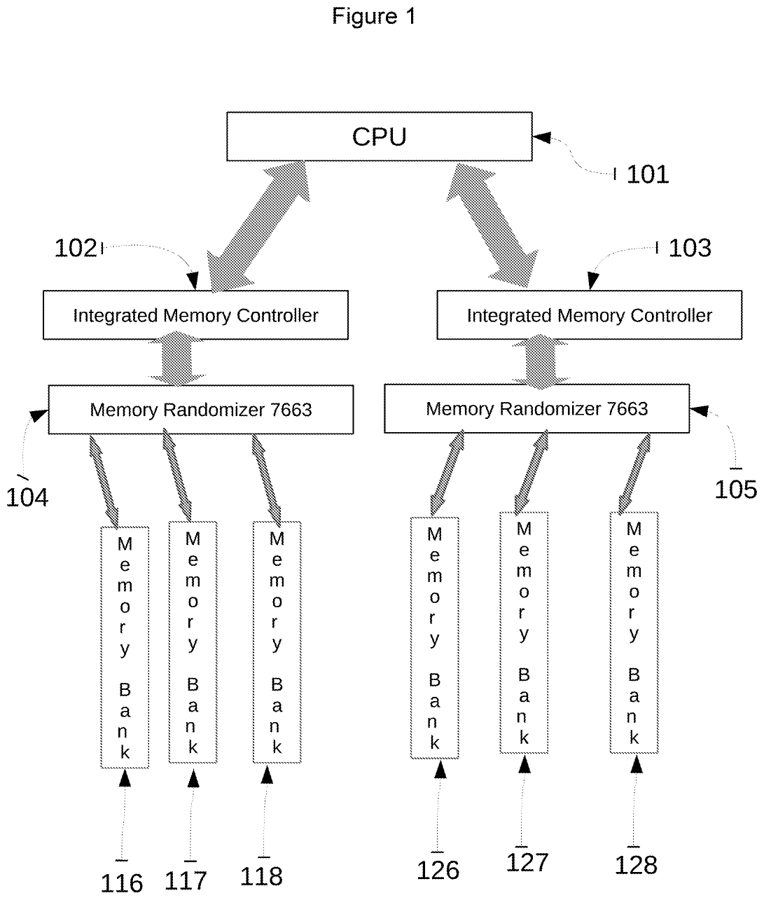

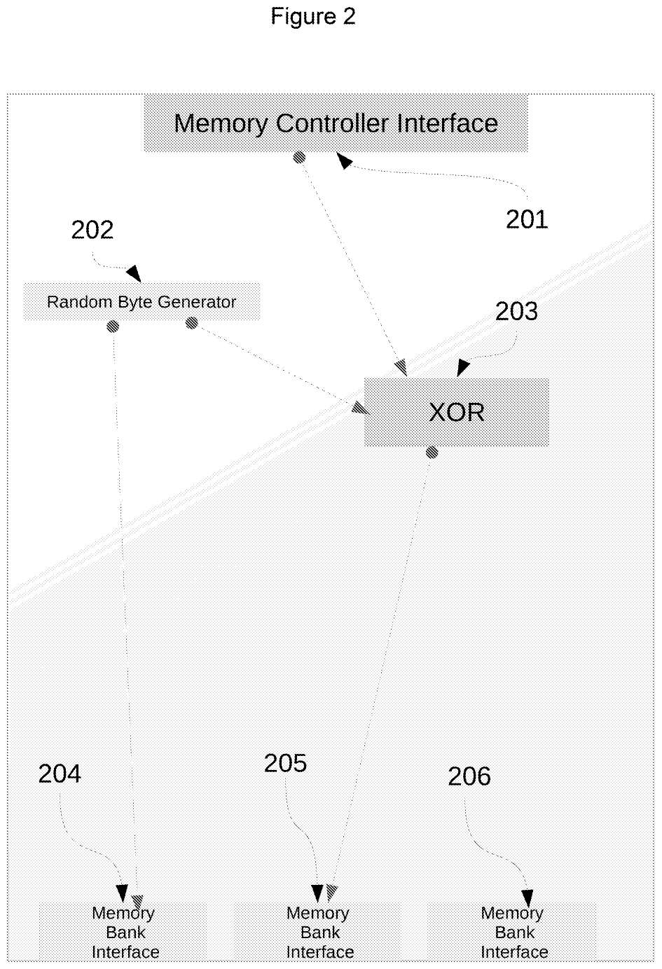

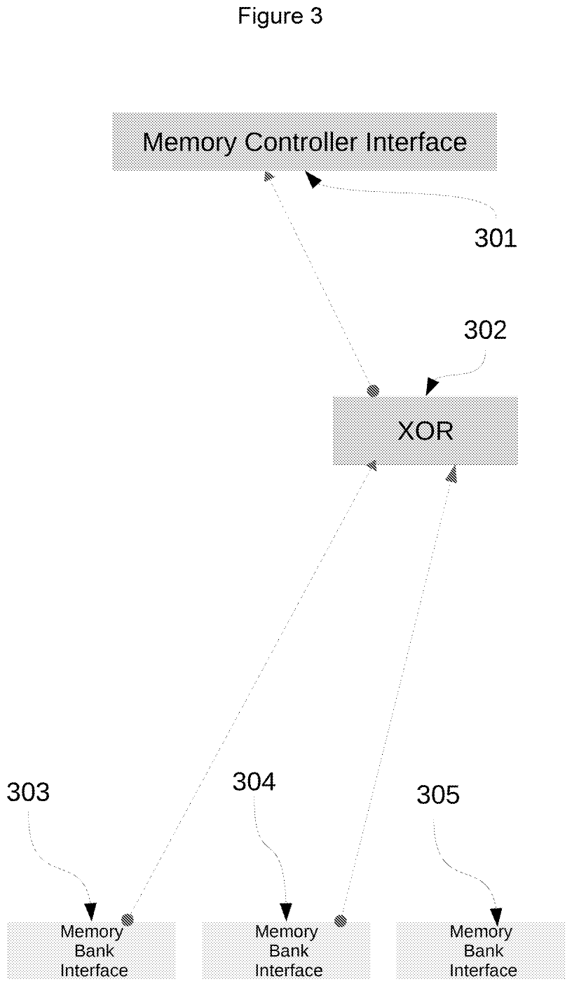

FIG. 1 is a block diagram illustrating reversible removal of information from data, and the storage of that data in memory (for example banks that have separate bus and I/O structures). The illustrated example is of a common memory storage format including multiple integrated memory controllers (IMC) (although multiple are not necessary) with the addition of Memory randomizer circuitry (either integrated on chip with the IMC or implemented as an additional chip. Memory Banks 116, 118 and 126, 128 are required to have separate circuitry from the IMC thru the MR7663 to the Memory Bank. The use of common memory banks, while it will work, is somewhat less secure. In this example the CPU 101 instructs the Integrated memory controller 102 to store information to memory 116, 118 and 126, 128. The IMC 102 passes the information to the Memory Randomizer 7663 (MR7) 104. The MR7 either generates random bytes (FIG. 2) or accesses random bytes from memory (FIG. 3) and XORs these random bytes with the information from 102 and stores the random bytes in memory bank 116 (MB116) and the XORed information/random bytes in memory bank 117 (MB117). Neither MB116 nor MB117 contains any information. If memory were dumped the dump would contain no information. If either memory bank or both were compromised neither would contain any information. The information is secure from the IMC to final storage.

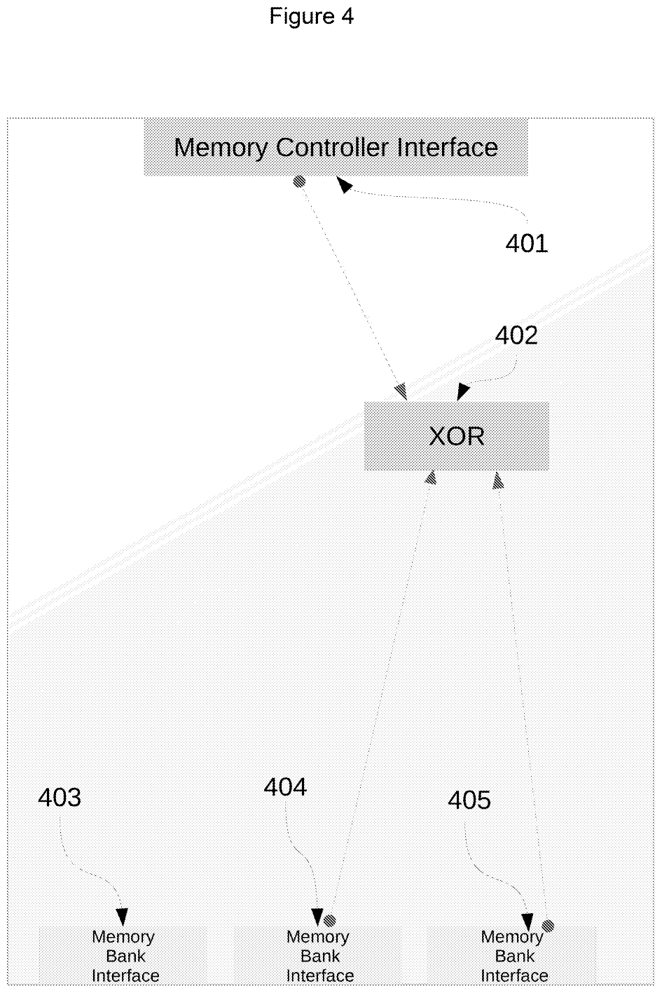

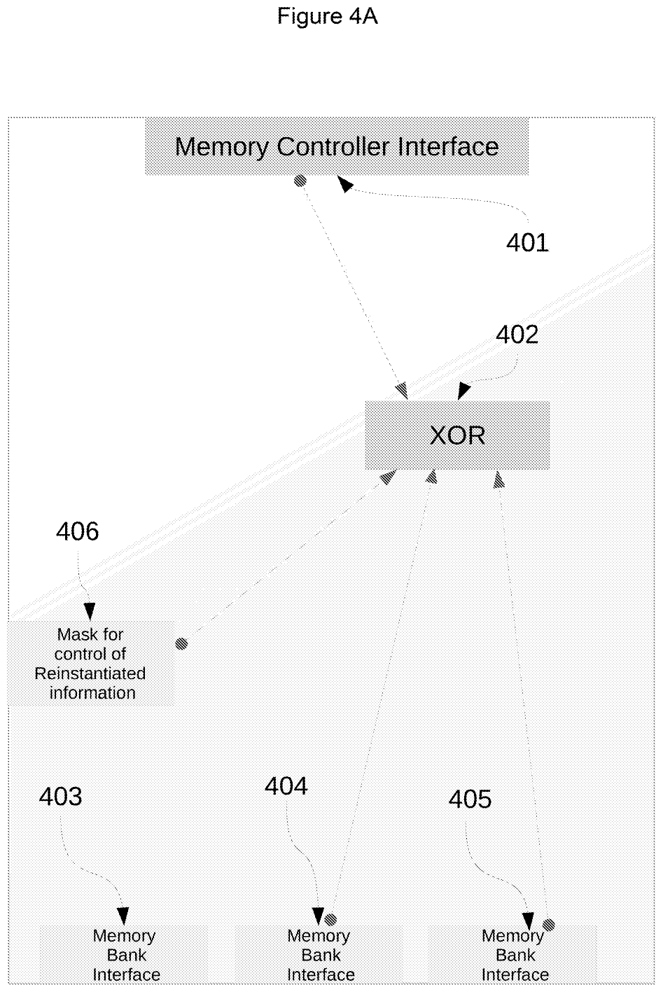

The information can be re-instantiated by using an inverse function 402 (FIG. 4) which must have access to the stored non-informational data stored in MB116 and MB117. The non-informational data stored in MB116/MB405 is XORed by 402 with the non-informational data MB117/MB404 resulting in the original information being available at the memory interface controller MIC401

FIG. 1 is not dependent on the specific architecture shown. Any architecture that allows the storage of information (for instance thru a Northbridge or Southbridge sub controller) works exactly the same way, allowing for differing points of insertion of the MR7 in the circuitry.

With regard to FIG. 2 a wide variety of functions may be used as the functions 203/302/402 to generate the non-informational data stored in MB205 (for instance without limitation) from the informational data. In the examples the illustrated function 203/302/402 is an XOR (exclusive OR) function. The XOR function outputs a logical “1” only when the inputs differ, e.g. (non-informational data from 202/304

In some implementations the non-informational data 202 is a pseudorandom value or the output of a free running clock. For example, the non-informational data 202 may be a pseudorandom string of bits that is generated by a DRBG (deterministic random bit generator) either on the CPU chip or on IMC (MCC, MCU) or from a free running clock on IMC or MCC/MCU The DRBG may be initiated by a seed that is a fixed value, a random value generated by the CPU or a free running clock. A given seed will generate the same non-informational data 202 each time the DRBG function is invoked, and different seeds will generate different non-informational data 202. Because using a key with the DRBG will always generate the same “random data” this may be useful for testing.

In some implementations the non-informational data 202 is arbitrary but meaningful digital data which can be useful for testing by searching memory for this known data pattern.

Those familiar with the current state of the art will be aware that the memory interface controller IMC/MCC/MCU interfaces not only with physical memory, but also with multiple other logical devices and busses. This technique also applies to all of these devices and busses.

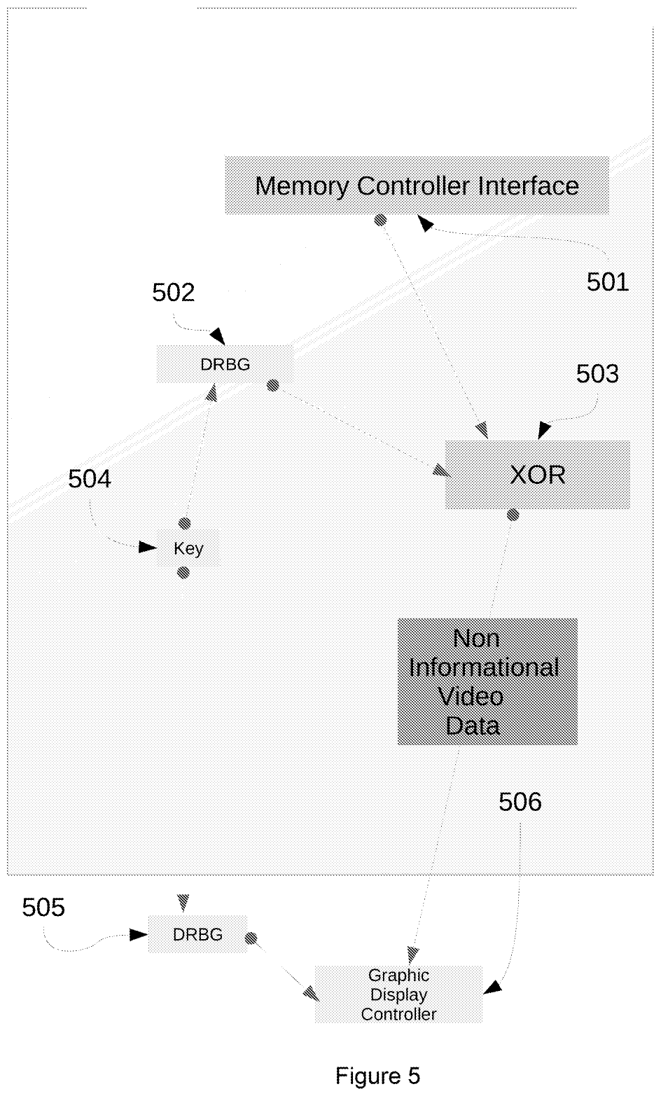

For instance, it is possible to separate video data such that two streams are necessary at the external video controller (GPU) to re-instantiate the video to be displayed. This has important implications for security where the video is the information. One possible implementation is shown in FIG. 5. Those conversant in the art can understand that this technique also applies to all such digital data being shipped to an external device.

This is possible with any devices connected either physically or logically in parallel to a IMC/MCC/MCU or similar device on or directly connected by bus to the CPU. Memory bank interface on FIG. 2 (204, 205, 206) could be a PCI-E interface, a SATA interface, a IDE interface, a USB interface, or any current or future extensions of this concept. If 204 and 205 were SATA interfaces to logically (or physically) different SATA devices, the entire process from the CPU outward would never contain any information, and the SATA devices would never contain any information. Any loss or compromise of the SATA devices would not compromise security.

Those versed in the art will understand that this applies to anything that applies to the CPU bus, including any extensions to that bus. If graphic memory attached to the CPU contains non-information (FIG. 2), then the devices that access Graphic memory will have to re-instantiate the graphic data before displaying. This requires the ability to re-instantiate the information and access to the appropriate non-informational portions of memory.

It is possible to run parallel PCI-E controllers with totally separate channels such that this information once processed by a device like 203 would only contain non-information from the PCI-E bus thru to the final storage or usage device at the end of the PCI-E chain. At no point would information exist after the 203 device (which could be implemented on the CPU chip itself, or implemented in a BIOS routine. All of this is possible similarly with SATA, IDE, USB—anything that is connected to the bus.

Since it is possible to never store information—not in memory and not in any connected devices—and to re-instantiate this information only in the CPU registers, it will be clear to those conversant with the art that by using this technique it is now possible to provide all sorts of computation and logical operations on non-information. No information is ever required to be stored outside the registers of the CPU. This meets the homomorphic encryption concept.

In addition to each of the capabilities above it is possible to add a third, 4^{th}, 5^{th} etc. string 406 that is XORed with stored non-information that will effectively mask off information that is not necessary for the current operation. For instance, using such a mask with a homomorphic encryption technique will allow only the specific piece of information that is required to be re-instantiated. If a record is brought in from a SATA drive via the bus, only the specific information necessary for the CPU can be masked off utilizing an additional string being XORed at 402

It is understood by one skilled in the art that any reference in writing or pictorially to a “Memory Bank Interface” such as 403, 404, and 405 could be replaced with a SATA drive interface, IDE drive interface, USB interface or any other interface available on devices similar in function to Southbridge and Northbridge chips.

In FIG. 5, MIC 501 supplies valid digital video data to XOR gate 503. DRBG 502 supplies the other non-informational data to XOR gate 503. The output of XOR gate 503 is non-informational video data that is supplied to the external Graphic Display Controller 506. This data when XORed with the output of DRBG 505 (also supplied by key 504 re-instantiates the valid video data for display.

One implementation of the foregoing instantiation and re-instantiation capability is a device that boots its OS over the web and has no local storage. Everything is done in memory which goes away when the device is turned off. Informational data is re-instantiated in memory from data D and data E using TES and displayed on the device's screen, manipulated by the device's keyboard and mouse, and restored using TES over the web. Informational data is never stored, merely instantiated. Nothing exists that can be compromised. Destination specific encoding for the OS which is maintained in a secure location using TES, and storage and retrieval are both non-informational.

The foregoing improvement can be further improved by the following implementations.

Data Aggregation

Data can be aggregated in a secure manner that is friendly to Personally Identifiable Information (PII) by having the data stored by an appropriate government, international institution or institution utilizing standard TES processes. All of the PII data (or Secret, or TOP Secret, etc.) can be obliterated with a mask using TES techniques that prevents its instantiation. Access can be given to authorized persons to the database, and they can scan each record, add it into the aggregation, and go on. A single TES secured copy of the data can be kept and all can share. If the owning authority wants even closer control, the researcher seeking to aggregate information may be required to provide a “needs and uses” document. Upon receiving and approving this document the researcher can be given a mask that will reveal only the information authorized. A researcher seeking to determine the prevalence of heart disease in Asian population in Maryland, for example, can be given a mask that reveals the diagnosis, the race, and the state.

The researcher now has the data he needs without having to have the data owner (a piece of information kept in the data base) do a select on a subset of his data and send it to the researcher.

Data owners can maintain control over their data in this storage by putting a data owner mask that would only reveal what the data owner wishes to make available to researchers. Even if the authority has approved the researcher according to the needs and uses document, and even if they provide the mask to reveal the data, if the data owner has masked it will not be revealed.

One data set, many controllers each with their own authority and policies. All have to agree before anything is revealed. The advantage here is that instead of making subsets of the data (which would not be back traceable should proof be required unless PII is revealed) and transmitting these subsets (which will become out of synchronization as the master changes) to individuals with a data need, the users with a need will simply pull authorized data from the master. This enables a single point of control and masking, a single point to update, with fewer people and systems having access.

The process of aggregation is as follows, with variation that will be evident to those skilled in the art:

Investigator (or data owner) adds data to the data store that is traceable and provides a mask such that only specific data is revealed. (There can be different reveal masks for different parties).

This data is spun out to the data store using TES and the data owner's reveal mask is stored along with the data.

A researcher submits a “needs and uses” document requesting access to specific data within the data store.

The data controlling authority reviews the needs and uses document and if approved provides a mask that will reveal the requested data (which is traceable because the data set is traceable back to the original contributor).

The researcher can then access the data store SUBJECT TO 1) the mask provided by the data controller and 2) the mask provided by the data owner.

If the data owner has allowed something that the data controller has not it will not be revealed; if the data controller has allowed something that the data owner has not it will not be revealed; both the owner and the controller must provide access via a mask.

Additional parties can add masks if authorized and these can be applied also.

Additionally, there can be a mask for the person who is logged in and/or the workstation (identified by MAC or IP #) limiting their access.

There is no practical limit to the number of masks. From a workload standpoint 1000 masks are just as quick as a single mask since all masks are combined once and only that final mask is applied to reveal the data.

Today this can be accomplished alternatively by meta-data in a data store but this would rely on each programmer to check the meta-data to determine for his/her application whether the data is appropriate. And when the meta data changes one would have to go back to each application program and update it, a very time consuming and failure prone process. Thus use of the invention is an improvement upon the existing art.

International Franking

If stored (and franked by using a random string known only by the international institution) use of TES by an international institution agreed to by multiple parties, the document becomes immutable without the cooperation of the international institution. Using this “International Franking” with block chain could provide provenance and immutability to the blockchain. This would be an important consideration if countries were to adopt blockchain for currency or other primary documents.

“HIPPA” Application

This is a concept of an instrument that is nontraditional and contains an executable operating system and application and a processor to run them. The device plugs into an interface that provides output and input for humans and a connection to the web. In executing the application it uses only TES stored data and it can display information, modify it, extend it, and restore it in TES style back on the web. It stores no data locally (except enough boot code to load its OS from the web (TES style) and perform it's applications. Since the OS is stored TES style it cannot be modified in an unauthorized manner (it has 2 sides controlled by 2 different staffs, and any attempt to modify one side fails because the OS won't execute if either side is modified). Since it is rebooted each time it is inserted there is no legacy bugs/worms/etc. retained unlike a workstation. If lost or stolen it is useless and meaningless and can be replaced for about a dollar.

The device contains a CPU, interface for display and input, and interface to a network (local or internet). It contains a boot program on non-modifiable memory. The boot program can get an address by DHCP or similar protocol, and can boot an OSA (Operating System and Application) from a remote TES data store (similar to boot, but TES style). This device can execute the application and provide all functionality but can only receive data from a TES style data store and store using only TES style storage. Since the TES storage has masks the boot, data, and application can be limited by the location where it is plugged in and the authorities granted by the masks.

To obtain a bank balance, for example, and do banking transaction, simply plug in a device that will download the proper OSA which is locked to the bank application. Only on the display is the information instantiated. Everywhere in transmission the banking information is non-informational data.

Similarly, to view or update patient data, simply plug a device into an interface in the hospital. It will contain only enough information to identify the patient and will download an OSA to accomplish what I want with respect to the patient with no information ever until it is displayed (information instantiation) the only place information will ever exist will be after instantiation, everything else—storage, transmission etc. will be non-informational data.

Destination Specific Encoding

By including a mask that is indigenous to the end device (which can obviously mask off anything that the end device has no need of) transmission of data can be made end device specific. Any other device receiving the data would receive no information. This indigenous mask may be created from (by some manipulation or process) or consist of anything that the two communicating sides know or can discover. Consider a mask element (which will be expanded to provide a full mask by some process of addition or manipulation) that is IP address and MAC. If the same machine is moved to a different IP address then the encoding will change for the new IP address, or if the machine utilizes a different interface (MAC ADDRESS) the encoding will change for this new interface.

Any other party watching the data exchange will only see non-informational data. If an Operating System Update is sent to a Cash Machine at a branch bank it can be done remotely using this TES based technique. It is not necessary to send a technician to touch each and every cash machine. The update to the cash machine will be encoded specifically for the specific cash machine and to all other cash machines (and watching instruments) and will appear to be non-informational data.

Group Specific Keys

Group specific keys are merely a manifestation of masking. By adding a mask for a specific group (in addition to all other masks) information will be revealed or hidden based upon this mask also.

Conditional Information

Using TES technology information can be hidden, but it can also be destroyed. The original storage of data using TES is storing random data one place and the XOR of that random data and the information in another place. These two places must exist and be accessible to re-instantiate the data. TES technology provides for there being more than two places and more than two places required for re-instantiation. Even in these more than two instances destruction and hiding are simple.

If for operational purposes the data owner (and certain foreseeable circumstances would indicate that there might be multiple data owners—one for each side of the data) wishes the data to not exist, then by merely overwriting a single side of the data the information will no longer exist, nor is it recoverable. It is simply gone. Mathematically one could do things that might “reveal” what appears to be meaningful data, but the original data will cease to exist and is not recoverable.

By application of an appropriate mask, the data will be hidden from re-instantiation, this mask could be applied at any step in the process (including a data owner on one side applying it to prevent any re-instantiation without destroying the data).

If for security reasons an embassy is directed to destroy all data all they have to do is overwrite (deleting will not suffice, since the data is not destroyed, merely marked as deleted and may still be recoverable) one side of the data, and the information will cease to exist.

Various procedures associated with data storage and security may be used in conjunction with the concepts described herein. For example, and without limitation, encryption and compression, either alone or in combination, may be implemented on one or more of the informational data, non-informational data D, non-informational data E, and combinations thereof. Encryption and compression techniques are well understood by those of ordinary skill in the art.

A number of features, aspects, embodiments and implementations have been described. Nevertheless, it will be understood that a wide variety of modifications and combinations may be made without departing from the scope of the inventive concepts described herein. Accordingly, those modifications and combinations are within the scope of the following claims.

What is claimed is:

1. In a system comprising a processor in a computing device in an unrestricted domain that operates on informational data with non-informational data E to generate non-informational data D, the inverse of said operation on data E with data D restoring said informational data, data D and data E being stored such that one but not the other is stored in a first information-restricted domain, an improvement comprising:
a configuration of the computing device such that instantiation and re-instantiation of informational data is limited to transient registers.

2. The system of claim 1, wherein the system is used with masks to make a database accessible to researchers.

3. The system of claim 1 wherein the system is used to secure a franking document to enable international block-chain currency.

4. The system of claim 1, further comprising plug-in devices for displaying restricted information via an OSA from a remote TSA data store.

5. The system of claim 1, further comprising an end device configured specifically to identify the device using a mask.

6. In a method comprising generating within an unrestricted domain non-informational data D from an operation on informational data with non-informational data E, the inverse of said operation on data E with data D restoring said informational data, data D and data E being stored such that one but not the other is stored in a first information-restricted domain, an improvement comprising:
configuring the computing device such that instantiation and re-instantiation of informational data is limited to transient registers.

7. The method of claim 6 wherein the system is used with masks to make a database accessible to researchers.

8. The method of claim 6 wherein the system is used to secure a franking document to enable international block-chain currency.

9. The method of claim 6, further comprising plug-in devices for displaying restricted information via an OSA from a remote TSA data store.

10. The method of claim 6, further comprising an end device configured specifically to identify the device using a mask.
